(19) United States
(12) Patent Application Publication
(10) Pub. No.: US 2006/0108486 A1
(43) Pub. Date: May 25, 2006

(54) Apparatus for supporting an object on a wall

(76) Inventor: Joseph A. Nowak, Midland, MI (US)

Correspondence Address: JOHN MCCULLOCH, 5291 COLONY DRIVE NORTH, 1ST FLOOR, SAGINAW, MI, 48603, US

(21) Appl. No.: 11/328,392

(22) Filed: Jan. 9, 2006

Related U.S. Application Data
(63) Continuation-in-part of application No. 10/975,541, filed on Oct. 29, 2004.

(51) Int. Cl. A47B 96/00; F16L 3/08; F21V 35/00

(52) U.S. Cl. 248/225.21

(57) ABSTRACT

Apparatus for mounting a storage object, such as a cabinet or shelving unit, comprises a horizontal rail fixed to a vertical wall, the rail having a flange spaced from the wall to form a groove between the flange and the wall. An inverted J-shaped bracket secured to the object has a body portion terminating at its upper end in a reversely turned hook forming a lip which is accommodated in the groove between the rail flange and the wall. The rail and the bracket have engaged surfaces which avoid the imposition of torsional forces on the rail. The bracket is accommodated in a recess formed in that surface of the cabinet which confronts the wall and enables the cabinet to occupy a position flush against the wall. No part of the bracket extends beyond the side of the object, thereby enabling adjacent objects to abut one another.

### RELATED APPLICATION

This application is a continuation-in-part of application Ser. No. 10/975,541 filed Oct. 29, 2004.

This invention relates to apparatus for supporting an object, such as cabinet and shelving units, on a vertical wall and more particularly to apparatus for supporting such units flush against the wall.

### BACKGROUND OF THE INVENTION

Cabinets and shelving supports may comprise prefabricated units mounted directly on a vertical wall. Such units often are of considerable width, height, and weight and therefore require support devices of sufficient strength to support the units themselves, as well as the objects occupying such units. A number of known cabinet and shelving support units exist in the art for such purposes. Some of these known support units consist only of a mounting rail member on which a cabinet is mounted directly by means of slots which accommodate the rail member. In other units an additional support member is attached to the cabinet in a position to be mounted on the rail. Although some of the known support units function effectively in mounting the cabinets and shelving on the wall, problems are present in such units.

One problem encountered with some units is that the back of the cabinet is not maintained flush against the supporting wall. The cabinet thus does not have the same neat or finished appearance as a cabinet that is flush with the wall. A particular disadvantage of such a support unit is that the cabinet or shelving is inclined to the vertical which tends to effect twisting of the support rail structure.

Other support units enable the cabinet structure to be maintained flush against the wall, but do not permit multiple cabinets to be mounted side-by-side and flush against each other because the supports include parts that must project beyond the sides of the cabinets and therefore prevent adjacent units from face-to-face abutment. Accordingly, there is a need for a support construction having sufficient strength to support cabinet and shelving units and which maintain such units flush against the wall and against adjacent cabinets. The support apparatus disclosed herein enables these results to be achieved.

### SUMMARY OF THE INVENTION

Support apparatus according to the invention is particularly adapted to support cabinets, shelving, and related storage units flush against a vertical wall and includes an elongate mounting rail and at least one inverted, J-shaped bracket removably mounted on and longitudinally adjustable relative to the rail. The J-shaped bracket is secured to the cabinet unit in such manner as to enable the latter to slide longitudinally of the mounting rail and in a position flush against the wall, thereby avoiding the imposition of gravity-induced torsion or rocking forces on the support structure.

The elongate mounting rail has a planar body portion that bears upon and is flush with the wall and a first elongate flange that is spaced from and parallel to the wall and to the planar body portion. The spacing of the flange from the wall forms a groove between the flange and the wall. The mounting rail additionally may include a second elongate flange that is joined to the body portion and is coplanar with but vertically spaced from the first flange. Fasteners are used to secure the mounting rail to the wall.

The J-shaped bracket has a hooked lip adapted to overlie and embrace the first flange of the mounting rail and occupy the groove between the first flange and the wall. The lip also has a planar face adapted to bear flush against the rear surface of a cabinet. Each bracket is accommodated in a recess formed in the back of the cabinet, and each recess is of such size as to accommodate the mounting rail when the cabinet is hung. The bracket and the attached cabinet may be lifted, moved into engagement with the wall, and then lowered onto the mounting rail so that the lip of the bracket is accommodated in the groove between the flange of the mounting rail and the wall.

The mounting rail and the bracket may be made from aluminum, plastic, or any other material suitable for hanging cabinets, shelving, and the like. The planar body portion of the mounting rail may have a longitudinally extending notch or groove which facilitates the passage of a fastener through the rail into the wall.

### THE DRAWINGS

FIG. 1 is a fragmentary, side elevational view of a support unit according to a first embodiment of the invention;

FIG. 2 is an exploded side elevational view of the support unit;

FIG. 3 is a fragmentary, isometric view of the mounting rail and two brackets of the support unit; and

FIG. 4 is an exploded, side elevational view of a support unit according to a second embodiment of the invention.

### THE PREFERRED EMBODIMENTS

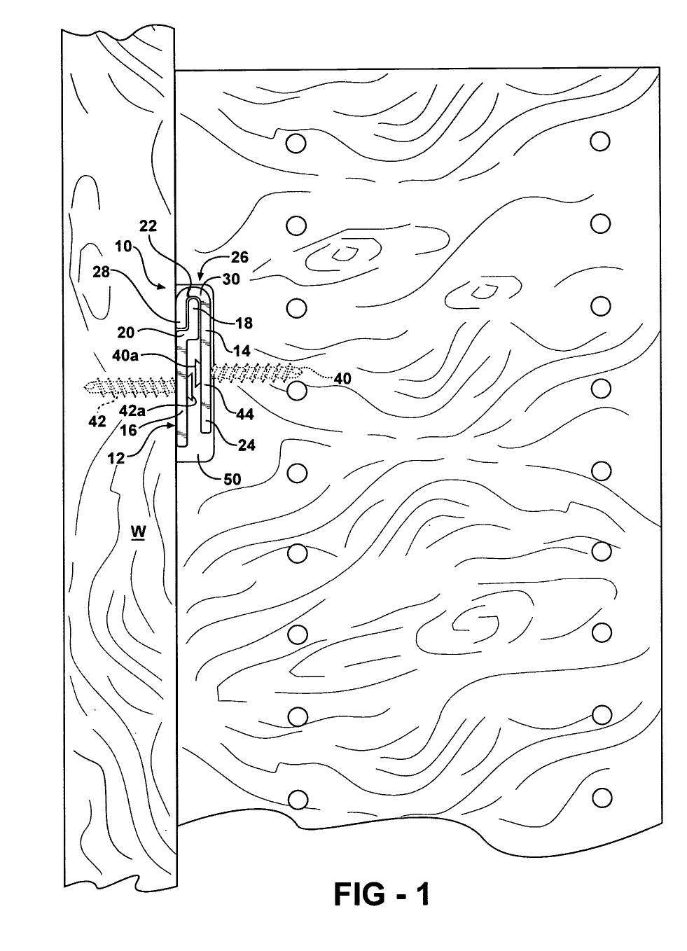

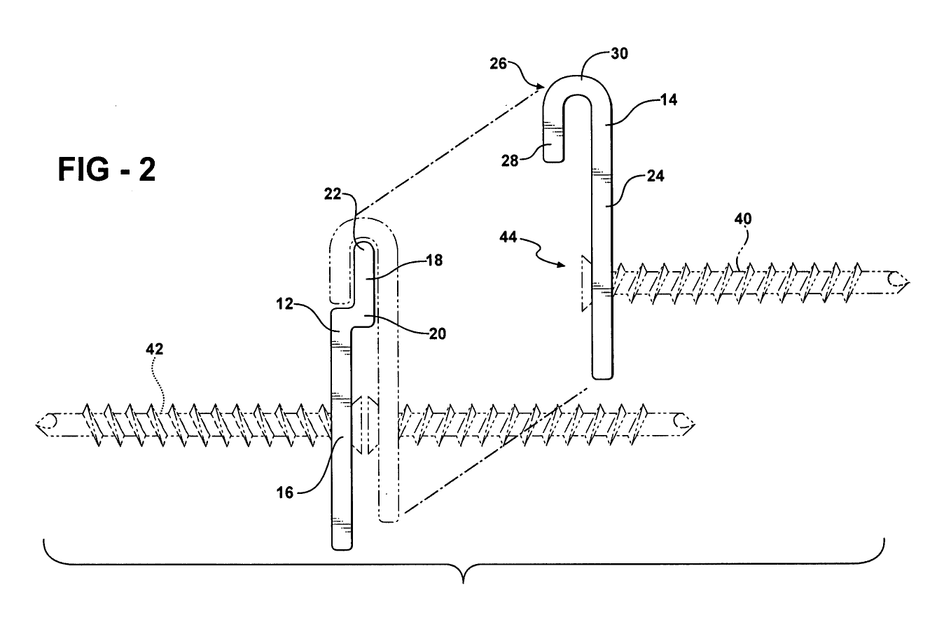

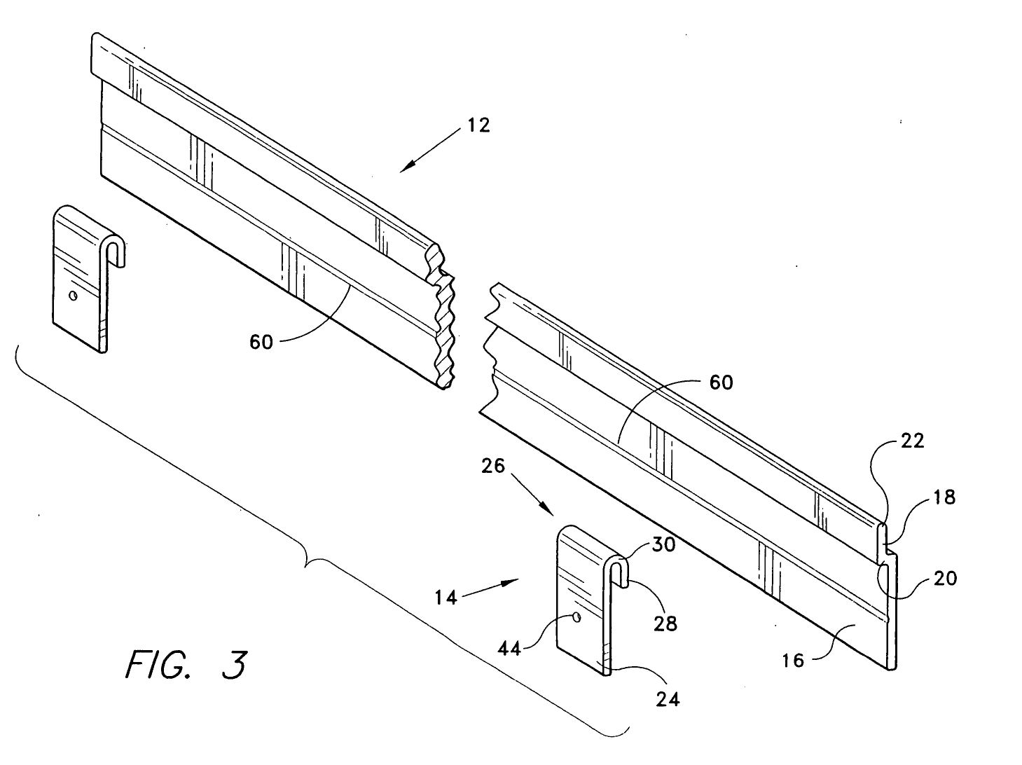

The support unit 10 constructed in accordance with the embodiment shown in FIGS. 1-3 is particularly adapted for supporting cabinet and shelving units C flush against a vertical, planar wall W.

As is shown in FIGS. 1-3, the support unit 10 comprises an elongate mounting rail 12 for supporting a plurality of inverted, J-shaped brackets 14 each of which is coupled to the cabinet C by a fastener such as a screw 40 having a head 40a. The mounting rail 12 is secured to the vertical wall W or other structure by a plurality of screws 42 each having a head 42a. Each bracket 14 is accommodated in a recess 50 formed in that face of the cabinet which confronts the wall W. The depth dimensions of the recess and the bracket 14 correspond so that the cabinet C, when supported on the rail 12, is flush against the face of the wall W. Preferably, no part of the bracket extends beyond the side edge of the cabinet.

The mounting rail 12 has a planar body portion 16 having an offset upper flange 18 extending longitudinally of the portion 16. The planar body portion 16 is adapted to seat upon the wall W. The offset flange 18 extends outwardly and parallel to the planar body portion 16. The flange 18 is offset from the body portion 16 by a short cross member 20 and terminates in a rounded upper edge 22. The cross member 20 is of such length as to provide a groove or space between the wall W and the flange 18 when the rail is secured to the wall. The planar body portion 16 of the mounting rail 12 is placed flush against the wall W in a horizontally level position. At least one fastener, such as the screw 42, is extended through the body portion 16 of the rail and into a wall stud or other frame member (not shown), thereby securing the mounting rail to the face of the wall W. The screw 42 preferably is a self-tapping screw of known kind.

The bracket 14 has a planar body portion 24 terminating at one end in a reversely turned hook 26 overlying the edge 22 and embracing the flange 18. The hook terminates in a planar lip 28. The body portion 24 of the bracket 14 has at least one fastener aperture 44 therein. The lip 28 is joined to the body 24 by a bight 30. The lip 28 is parallel to but spaced from the body 24. The lip 28 is of such thickness as snugly, but slideably, to occupy the groove between the wall W and the flange 18.

The vertical length of the body 16 of the rail 12, the opposite surfaces of the flange 18, the surfaces of the body 24, and the lip 28 which confront and engage the opposite surfaces of the flange 18 are such as to enable sliding support of the bracket and consequently the cabinet C longitudinally of the rail 12. These surfaces abut one another and therefore preclude rocking movements of the bracket and the cabinet toward and away from the wall W. The relative sizes and positions of the rail flange, the bracket, and the recess 50 are such that the rear surface of the cabinet C is flush against the wall, thereby further resisting the application of torsion forces on the support apparatus.

The fastener 40 may pass through the aperture 44 in the bracket 14 and be screwed into the cabinet C at a distance so spaced from the top of the latter as to avoid a likelihood of the screw's splitting the wall of the cabinet. The recesses 50 in the rear surface of the cabinet are of sufficient depth, height, and width as to accommodate the mounting rail 12 and the bracket 14 when the cabinet C is hung on the rail.

To mount the cabinet on the wall W the cabinet, following attachment of the bracket 14 thereto, may be lifted to a position in which the lip 28 is slightly above the upper edge of the flange 18, following which the cabinet may be moved toward the wall W and lowered so as to enable the lip 28 to occupy the groove between the surface of the wall W and the flange 18. In this position the lip 28 of the bracket 14 is coplanar with the body portion 16 of the mounting rail, and the back of the cabinet C occupies a vertical position flush against the wall W. Since the bracket 14 fits into the recess at the back of the cabinet C, and since no part of the bracket projects beyond the side edge of the cabinet, multiple cabinets may be supported on the wall W flush against each other.

If it becomes necessary or desirable to adjust the position of a cabinet longitudinally of the rail 12, such adjustment is possible because the heads 40a and 42a of the screws 40 and 42 occupy positions in which they may pass one another without interference.

The mounting rail 12 and the bracket 14 may be made from aluminum, plastic, or any other material suitable for hanging cabinets and the like. The support apparatus 10 is capable of holding up to 800 pounds and this is due in large part to the ability of the body portion 16 of the rail 12 and the bracket lip 18 to resist torsional forces.

The body portion 16 of the mounting rail 12 may have a channel or groove 60 of a thickness less than that of the remainder of the rail. The groove extends the full length of the rail making it easier to form a hole or aperture through the rail at any desired location thereof for the accommodation of a fastener. The groove may be V-shaped, rectangular, or any other desired shape.

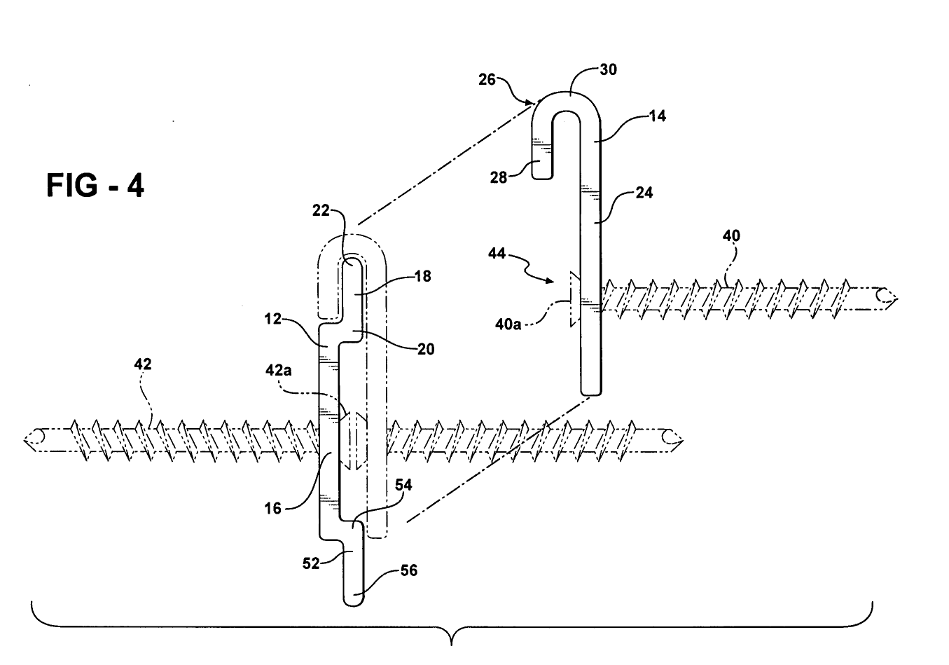

FIG. 4 illustrates a second embodiment of the support apparatus. The difference between the embodiments of FIGS. 1-3 and 4 is that that the rail 12a of the second embodiment has a second elongate flange 52 like the flange 18 except that the flange 52 is at the opposite edge of the body portion 16. The second flange 52 is offset from the planar body portion 16 by a second cross member 54 and terminates in a rounded edge 56. The second cross member 54 parallels the first cross member 20 and is of the same length, thereby enabling the flanges 18 and 22 to be coplanar. The rail 12a thus is symmetrical, thereby enabling either flange to be oriented upward or downward during installation of the rail on the wall W.

The bracket 14 is usable with either of the rails 12 and 12a. One of the advantages of using the rail 12a is that the body 24 of the bracket 14 is of such length as to span the distance between the flanges 18 and 22, as is shown in FIG. 4, and seat on both. This arrangement provides additional stability in maintaining the bracket body 24 in a vertical position, thereby precluding any rocking of the bracket body and the cabinet C about a horizontal axis and avoiding inclination of the cabinet and the imposition of any force other than vertical on the rail 12a. As a consequence, the cabinet is maintained flush against the wall.

In many instances a cabinet, or group thereof, may require adjusting from side-to-side. Since the mounting brackets are slideable relative to the mounting rails, and since the fastener heads 40a an 42a do not lie in the path of movement of one another, such heads do not interfere with sliding movements of the cabinets.

The disclosed embodiments are representative of presently preferred embodiments of the invention, but are intended to be illustrative rather than definitive thereof. The invention is defined in the claims.

I claim:

1. Apparatus for supporting an object on a vertical wall, said apparatus comprising a mounting rail; means for mounting said rail on said wall; a bracket; and means for mounting said bracket on said object, said rail having a body portion terminating in a first flange offset to one side from said body portion, said bracket having a body portion terminating in a reversely turned lip, said lip embracing said flange, and said body portion of said flange bearing upon said flange.

2. The apparatus according to claim 1 wherein the means for mounting said rail on said wall comprises a first screw having a head and the means for mounting said bracket on said object comprises a second screw having a head, the head of said first screw confronting the body portion of said bracket and the head of said second screw confronting said rail, the first and second heads being so positioned that said bracket is movable along a path parallel to said rail with no interference between the heads of said screws.

3. The apparatus according to claim 1 wherein said rail has a second flange offset to one side of said rail body portion and parallel to said first flange, said body portion of said bracket being of such length as to bear upon said second flange.

4. The apparatus according to claim 1 wherein said lip has a thickness corresponding substantially to that of said rail body portion.

5. The apparatus according to claim 1 wherein said lip is spaced from said bracket body portion a distance corresponding substantially to the thickness of said first flange.

6. The apparatus according to claim 1 wherein said object has a recess therein and wherein said bracket is accommodated in said recess.

7. The apparatus according to claim 6 wherein said bracket and said recess have corresponding dimensions.

8. The apparatus according to claim 1 wherein no part of said bracket projects beyond a side edge of said object.

9. In combination, an object, a vertical wall; and means mounting said object on said wall, said means comprising an elongate rail secured to said wall in a horizontal position, said rail having a planar body portion flush against said wall, a first flange spaced from said wall and extending upwardly from said rail body portion to form an upwardly open groove at a level above that of said rail body portion, a bracket secured to said object and confronting said rail, said bracket having a planar body portion terminating at the upper end thereof in a reversely turned, downwardly extending lip forming a space between said lip and said bracket body portion, said lip being accommodated in said groove and said flange being accommodated in said space, said groove and said lip having substantially corresponding thicknesses thereby enabling said bracket body portion to confront and bear upon said first flange.

10. The combination according to claim 9 wherein said bracket has a second flange extending downwardly from said rail body portion and being coplanar with said first flange, said bracket body portions spanning said first and second flanges and bearing upon both of said flanges.

11. The combination according to claim 9 wherein said rail and said bracket are secured to said wall and said object respectively by screws having heads which project beyond the respective rail and object a combined distance enabling said object to be slid longitudinally of said rail without interference between said heads.

12. The combination according to claim 9 wherein said object has a recess therein, said bracket being accommodated in said recess.

13. The combination according to claim 12 wherein no part of said bracket projects beyond a side edge of said object.

14. The combination according to claim 12 wherein said recess and said bracket have substantially corresponding depth dimensions.

15. The combination according to claim 9 wherein said rail body portion has a longitudinally extending groove therein defining an area of reduced thickness of said rail body portion.
